(19) United States
(12) Patent Application Publication
(10) Pub. No.: US 2026/0029360 A1
(43) Pub. Date: Jan. 29, 2026

(54) ELECTRIFIED VEHICLE BATTERY COMBINATION ELECTRICAL/ FLUID CONNECTOR

(71) Applicant: FORD GLOBAL TECHNOLOGIES, LLC, Dearborn, MI (US)

(72) Inventors: Thomas J. COUPAR, Ann Arbor, MI (US); Michael David BEENEY, Canton, MI (US); Philip Michael GONZALES, Dearborn, MI (US); Liam E. WEST, Ferndale, MI (US); Sangyeon KIM, Northville, MI (US)

(21) Appl. No.: 18/783,092

(22) Filed: Jul. 24, 2024

(51) Int. Cl. G01N 27/07; B60L 50/60; B60L 58/10; G07C 5/08; H01M 10/42; H01M 10/48; H01M 10/613; H01M 10/625; H01M 10/63; H01M 10/656

(52) U.S. Cl. CPC G01N 27/07; B60L 50/60; B60L 58/10; G07C 5/0808; H01M 10/425; H01M 10/482; H01M 10/613; H01M 10/625; H01M 10/63; H01M 10/656; H01M 2010/4271; H01M 2220/20

(57) ABSTRACT

An electrified vehicle system is presented. The electrified vehicle system has a traction battery incorporating a plurality of electrically connected array modules submerged in a cooling fluid. A sensing component, coupled with at least one array module and immersed in the cooling fluid, is configured to detect a voltage drop when the fluid's contamination level reaches a threshold, thereby increasing electrical conductivity. This sensed voltage drop is communicated to a traction battery monitoring system, enabling proactive management of cooling fluid integrity.

### TECHNICAL FIELD

This disclosure relates to battery cooling systems for use in electrified vehicles.

### BACKGROUND

Immersion cooling systems offer a method for controlling temperature in high voltage battery systems, including battery cells and exposed high voltage components. However, maintaining proper electrical isolation in these systems is necessary for performance. The dielectric strength of the immersion cooling fluid plays a role in this isolation. Contamination of the fluid can compromise its dielectric properties. Traditional methods for detecting isolation faults between high voltage positive or high voltage negative and chassis ground, are unable to detect dielectric breakdown in the cooling fluid caused by contamination.

### SUMMARY

In one aspect of the disclosure, an electrified vehicle system is presented. The electrified vehicle system includes a traction battery, a plurality of electrically connected array modules within the traction battery submerged in a cooling fluid, and a sensing component coupled with at least one of the array modules and in contact with the cooling fluid, configured to detect a voltage drop across the sensing component when a contamination level in the cooling fluid reaches a threshold that increases electrical conductivity of the cooling fluid, and report a voltage drop across the sensing component to a traction battery monitoring system. The sensing component may be a high-precision resistive shunt. The sensing component may also be a current sensor with low and high precision range capabilities. In other configurations, the electrified vehicle system may further include a plurality of sensing components, each coupled with a respective array module. The traction battery monitoring system may be configured to correlate the reported voltage drop with diagnostic data of a vehicle to determine a contamination level of the cooling fluid. The traction battery monitoring system may be further configured to classify the contamination level of the cooling fluid as low, medium, or high. The traction battery monitoring system may be further configured to disable one of the array modules based on the contamination level. The traction battery may be further coupled with a traction component.

In another aspect of the disclosure, an electrified vehicle system is presented. The electrified vehicle system contains a traction battery, at least one array within the traction battery, immersed in a cooling fluid, and a sensing component within the cooling fluid configured to detect a change in dielectric properties of the cooling fluid when a contamination level in the cooling fluid reaches a threshold that alters dielectric strength of the cooling fluid, measure the change in dielectric properties resulting from voltage flow of the at least one array through the cooling fluid, and communicate the measured change in dielectric properties to a traction battery monitoring system. The dielectric strength of the cooling fluid is measured by the sensing component and may include at least one of electrical conductivity, dielectric constant, or impedance of the cooling fluid. The sensing component may comprise multiple electrodes positioned at different locations within the cooling fluid. The electrified vehicle system may further comprise a plurality of sensing components, each associated with a different array within the traction battery. The traction battery monitoring system may be further configured to establish a baseline measurement of the electrical properties and detect deviations from the baseline measurement. The traction battery monitoring system may be further configured to classify the deviation as indicating low, medium, or high contamination. The traction battery monitoring system may also be configured to correlate the measured change in electrical properties with diagnostic data of a vehicle to determine a contamination level of the cooling fluid. The diagnostic data may include temperature measurements of the cooling fluid. The traction battery monitoring system may be further configured to disable the at least one array based on the measured change in electrical properties. The traction battery may be connected to a traction component.

In yet another aspect of the disclosure, a battery module is presented. The battery module includes a housing with a plurality of arrays within the housing, an immersion cooling fluid within the housing, in contact with a positive terminal and a negative terminal of the plurality of arrays, a contamination detection circuit coupled with at least one of the plurality of arrays and in contact with the immersion cooling fluid, the contamination detection circuit configured to detect a current flow between the positive terminal and the negative terminal through the immersion cooling fluid when a contamination level in the immersion cooling fluid reaches a threshold that completes an electrical path, and a battery module monitoring system configured to receive data indicative of the current flow from the contamination detection circuit due to a contamination level of the immersion cooling and disable one of the plurality of arrays based on a determination that the contamination level has reached the threshold. The battery module monitoring system may further be configured to adjust a charging rate of the plurality of arrays based on the determined contamination level.

### BRIEF DESCRIPTION OF THE DRAWINGS

FIG. 1 is a schematic diagram of an electrified vehicle system according to one or more aspects of the disclosure;

FIG. 2 is a schematic diagram of an electrified vehicle system according to one or more aspects of the disclosure; and

FIG. 3 is a block diagram of an electrified vehicle system according to one or more aspects of the disclosure.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the claimed subject matter.

The introduction of immersion cooling technology in high voltage (HV) battery systems for electric vehicles has allowed for new forms of thermal management and performance optimization. This approach, involving submerging battery cells and associated HV components in a specifically formulated dielectric fluid, offers advantages over traditional air or liquid cooling methods. The benefits include increased heat transfer capabilities, a higher degree of uniform temperature distribution across the battery pack, and the potential for increased energy density. However, with immersion cooling technologies there may be difficulty in maintaining the integrity of the electrical isolation within the system.

The dielectric fluid is a component of immersion cooling systems. The dielectric fluid is a specifically engineered substance that should balance multiple properties. An example immersion coolant possesses high dielectric strength to maintain electrical isolation, low viscosity for efficient circulation, high thermal conductivity for effective heat dissipation, chemical stability to prevent degradation under varying conditions, and low toxicity for environmental sustainability. Choices for immersion cooling fluids include silicone oils, synthetic hydrocarbons, and specialized fluorinated liquids. Each type of fluid offers a profile of properties, and the selection process involves consideration of the specific requirements of the battery system, including operational temperature range, expected lifespan, and stability considerations.

The dielectric strength of the immersion cooling fluid plays a role in the stability and functionality of the HV battery system. The dielectric strength of the immersion cooling fluid allows the fluid to function as an effective insulator, preventing unintended electrical connections between HV components or between HV components and the vehicle chassis. However, the dielectric strength of the fluid may be compromised by various forms of contamination. Moisture ingress, even in minute quantities, can reduce the dielectric strength of the fluid. Particulate matter, which may enter the system from external sources or be generated internally through component wear, can create conductive pathways within the fluid. Over time, the fluid itself may undergo chemical degradation due to thermal stress or reactions with battery materials. In the event of cell impairment, battery electrolyte leakage into the cooling fluid can may also affect its insulating properties.

Methods for detecting isolation faults in HV battery systems focus on monitoring the electrical isolation between either the HV positive (HV+) or HV negative (HV−) and the chassis ground. These methods may be insufficient to fully address the specific challenges posed by immersion cooling systems. A consideration in immersion-cooled systems is the possibility of a dual fault scenario, where contamination of the cooling fluid may result in connections between both HV+ and HV− to the chassis ground. This scenario requires consideration due to its implications for the battery and necessitates the development of improved detection and monitoring systems.

The present disclosure presents an approach for detecting and monitoring dielectric breakdown in immersion-cooled HV battery systems. The presented system utilizes high-precision current measurement techniques to detect minute current flows that may indicate fluid contamination or the onset of dielectric breakdown. This is achieved through the placement of high-precision shunts or advanced current sensors capable of measuring currents in the microamp to milliamp range. These sensors are configured to detect current flow through the cooling fluid between HV+ and HV− components, providing early indication of potential isolation issues.

The current measurement system may be integrated into a Battery Management System (BMS) or integrated with dedicated Battery Pack Sensor Modules (BPSMs), allowing for increased diagnostic ability. This analysis may correlate the current measurements with a wide array of existing diagnostic data, including cell voltage disparities, pack self-discharge rates, and temperature distribution anomalies. Algorithms may process this data to differentiate between normal operational currents and those indicative of dielectric breakdown, enabling the system to identify potential issues with high accuracy and minimal false positives.

In the presented approach, the implementation of isolation monitoring at the array or module level is considered, rather than relying solely on pack-level checks. Each battery array may be equipped with its own BPSM, capable of performing localized isolation checks independently. This granular approach allows for precise fault localization, enabling the system to distinguish between array-specific issues and system-wide contamination events. The distributed nature of this monitoring system enhances overall reliability and provides data for predictive maintenance and fault diagnosis.

The disclosure may also incorporate passive measurement techniques configured to operate with minimal power consumption. This allows for continuous vigilance against developing faults, even when the vehicle is in a dormant state. The system may also perform rapid checks upon BMS or BPSM wake-up, to allow for the detection of potential issues promptly without significantly impacting the vehicle's energy efficiency.

Responding to detected faults may be managed through a tiered response system. The severity of the detected issue may determine the appropriate action, ranging from the activation of diagnostic trouble codes or indicators for minor situations, to limiting charge/discharge rates or power output for more significant scenarios, and up to complete vehicle start inhibition and immediate protocol activation for the most severe events. This approach balances user convenience with operational reliability to maintain vehicle functionality when possible.

The integration of monitoring points within the fluid circulation system, including the pump and chiller controller, may increase the system's detection capabilities. By utilizing both the high voltage and low voltage sides of the pump/chiller system for redundant checks, the presented approach may provide a comprehensive view of fluid health throughout the entire circulation path.

The implementation of this detection system may involve specifically configured hardware and software components. High-precision resistive shunts or advanced Hall-effect sensors may be employed for current measurement, capable of detecting even the slightest anomalies in current flow. The BMS and BPSM software may further incorporate machine learning algorithms that analyze current data in real-time, considering factors such as normal leakage currents, temperature-dependent variations in fluid conductivity, and transient currents during vehicle operation or charging.

Each BPSM may be equipped with dedicated microcontrollers capable of performing isolation checks independently, contributing to a robust and fault-tolerant system architecture. Data from all arrays may be aggregated and analyzed by the central BMS, which may employ pattern recognition techniques to identify and differentiate between systemic issues and localized faults. This distributed yet integrated approach allows for comprehensive monitoring while enabling rapid and accurate fault diagnosis.

The passive measurement system may also incorporate ultra-low-power components, allowing for periodic checks even during extended periods of vehicle inactivity. This may allow for the detection of slow-developing faults that might otherwise go unnoticed between drive cycles, for increased reliability and performance.

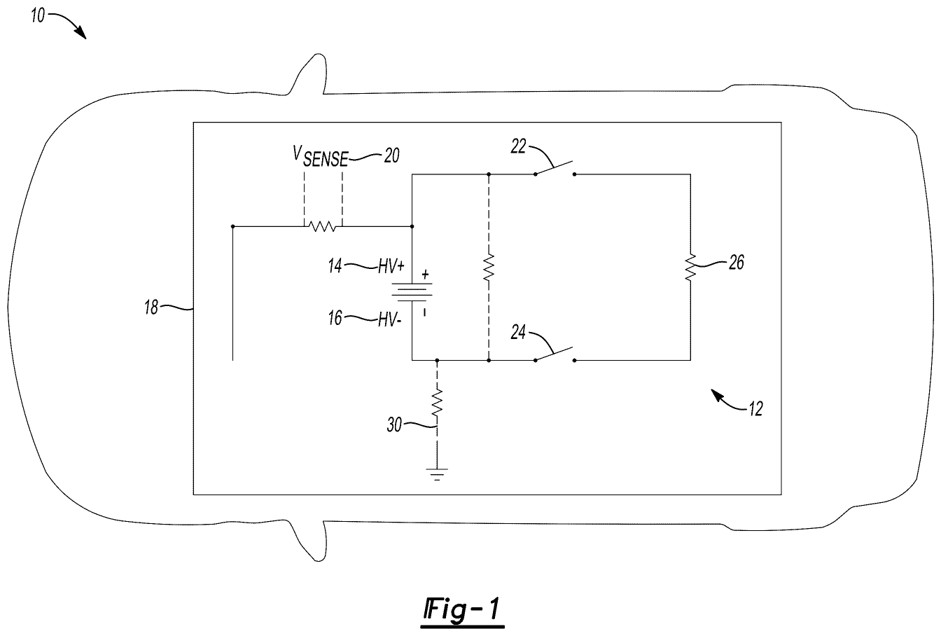

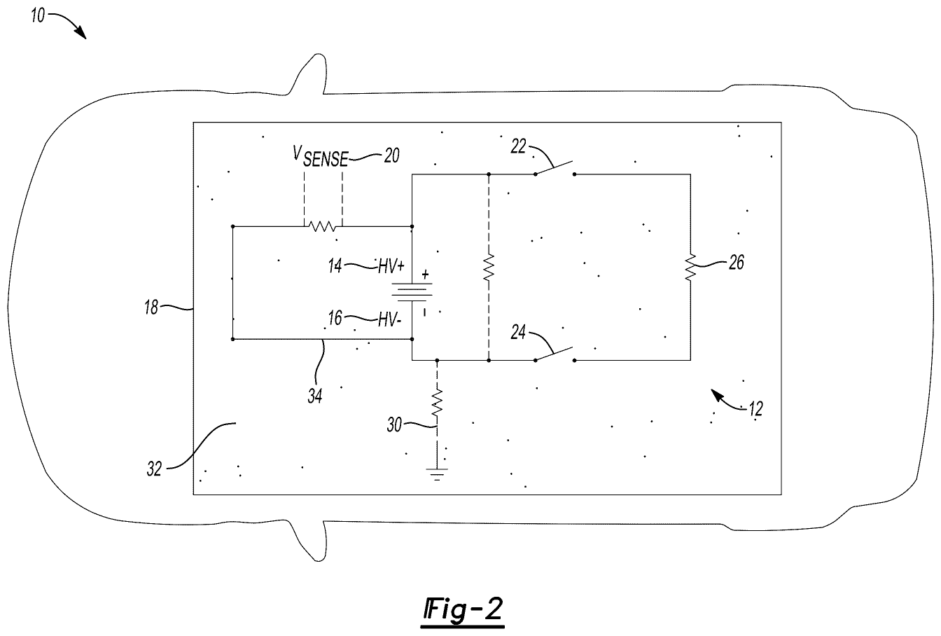

FIGS. 1-2 are schematic diagrams of a battery monitoring system 10 within an electrified vehicle system. The traction battery 12 has a HV positive terminal 14 and a HV negative terminal 16. The HV positive terminal 14 and the HV negative terminal 16 serve as the primary power conduits for an electric vehicle drivetrain. The traction battery 12 includes multiple array modules (not individually depicted in these figures) that are electrically interconnected to form a high-capacity energy storage system capable of powering the vehicle's electric motors and auxiliary systems.

The immersion cooling fluid 18, which completely envelops the battery components serves multiple functions. The immersion cooling fluid 18 provides heat dissipation from individual battery cells, ensures a uniform temperature distribution across the entire traction battery 12, and acts as a dielectric medium, maintaining electrical isolation between high-voltage components. Under normal operating conditions, the immersion cooling fluid 18 is configured to be non-conductive, thereby preserving the electrical integrity of the battery system.

The battery monitoring system 10 includes a sensing component 20. The sensing component 20 may be a precision resistor/shunt, this component is positioned in direct contact with the immersion cooling fluid 18. The primary function of the sensing component 20 is to measure minute current flows that may develop due to changes in the electrical properties of the immersion cooling fluid 18. The sensing component 20 may be capable of detecting extremely small voltage drops across itself, which serve as sensitive indicators of alterations in the fluid's electrical conductivity.

The system 10 incorporates a positive contactor 22 and a negative contactor 24. These are high-voltage switching devices that control the electrical connection between the traction battery 12 and a HV load 26. These contactors 22, 24 serve as measures, allowing for rapid electrical isolation of the battery 12 from the rest of a vehicle's HV system in the event of a detected fault or during maintenance procedures.

A high resistance component 28 represents the substantial electrical isolation maintained between the traction battery 12 and chassis ground 30. The high resistance component 28 preserves the electrical integrity of the vehicle, effectively preventing unintended current paths between the traction battery 12 and a vehicle's conductive body structure.

The HV load 26 represents the electrical load from the various HV components in a vehicle that draw power from the traction battery 12. This may include, but is not limited to, the electric drive motor, power electronics for motor control, and HV heaters or air conditioning compressors. The chassis ground 30 provides a common reference point for all vehicle electrical systems and ensures that any stray currents have a predetermined path to ground.

The physical contact the immersion cooling fluid 18 makes with the HV positive terminal 14, HV negative terminal 16, and the chassis ground 30 allows the immersion cooling fluid 18 to normalize the temperature of these components. Under normal circumstances, the dielectric properties of the immersion cooling fluid 18 prevent any current flow between these points. However, if contaminants infiltrate the fluid and alter its electrical characteristics, potential current paths may form. The sensing component 20 is configured and positioned to detect these currents, which manifest as small but measurable voltage drops across the component.

The arrangement of the battery monitoring system 10 shown in FIGS. 1-2 allows for continuous, real-time monitoring of the cooling fluid's condition. Any increase in the electrical conductivity of the immersion cooling fluid 18, which may be caused by the presence of conductive contaminants 32 or breakdown of the molecular structure of the immersion cooling fluid 18, may result in a detectable current flow through the sensing component 20. This current flow produces a voltage drop across the sensing component 20, which may be precisely measured and analyzed by the battery monitoring system 10. As shown in FIG. 2, when the conductive contaminants 32 have reached a threshold level, a circuit 34 between the HV positive terminal 14 and HV negative terminal 16 is completed.

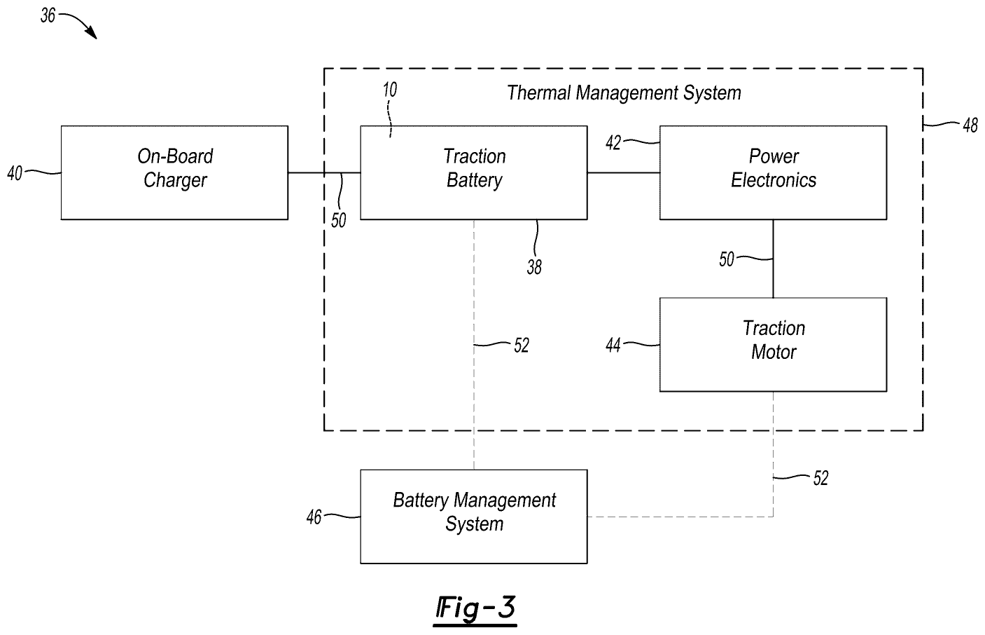

FIG. 3 is a block diagram of the overall electrified vehicle system 36, showing the relationships between major components and subsystems. Traction battery 38 is a HV battery pack that serves as the primary energy storage unit for an electrified vehicle, providing the requisite power to drive the vehicle and operate its myriad electrical systems. The traction battery 38 includes array modules and the battery monitoring system 10 described in FIGS. 1-2. Coupled with the traction battery 38 is an on-board charger 40. This on-board charger 40 converts alternating current power from external charging stations into the direct current power required to charge the traction battery 38. The on-board charger 40 coupled with the traction battery 38, represents the high-voltage direct current charging circuit. This circuit may be designed to handle high power levels, often in the range of 50 to 350 kW, depending on a vehicle's fast-charging capabilities.

Further coupled with the traction battery 38 are power electronics 42. The power electronics 42 serve as the interface between the traction battery 38 and traction motor 44. The power electronics 42 may include inverter systems that convert the direct current power from the traction battery 38 into alternating current power required by the traction motor 44. Additionally, the power electronics 42 may manage bidirectional power flow, enabling regenerative braking by converting kinetic energy back into electrical energy to recharge the battery 38. The power electronics 42 may be coupled to the traction motor 44, which may include HV power circuits. The HV circuits may be configured to handle high currents, often exceeding 1000 amperes during peak load or regenerative braking events.

The traction motor 44 is the primary propulsion unit of the vehicle, responsible for converting electrical energy from the battery 38 into mechanical energy. The traction motor 44 may be of various types, such as permanent magnet synchronous motors or induction motors. The power electronics 42 coupled with traction motor 44 represent the high-voltage alternating current power circuit that supplies the controlled, variable frequency and amplitude power needed to operate the traction motor 44 efficiently across a wide range of speeds and torques.

A battery management system 46 is the control unit of an electric powertrain, monitoring and managing various aspects of the operation of the traction motor 44 and the traction battery 38. The battery management system 46 is connected to the traction battery 38, power electronics 42, and traction motor 44. These connections represent the control and communication circuits that allow the battery management system to monitor and control these components. These circuits carry a multitude of signals, including battery cell voltage and temperature data, state of charge and state of health estimations, cooling fluid contamination sensor data, power demand signals to the motor controller, charging current and voltage control signals, and fault detection and mitigation commands.

Encompassing the traction battery 38, power electronics 42, and traction motor 44 is a thermal management system 48. This system is responsible for maintaining optimal operating temperatures for these components. It includes an immersion cooling system for the traction battery 38, and may also include liquid or air-cooling systems for the power electronics 42 and traction motor 44. The thermal management system 48 plays a role in the efficiency, performance, and longevity of the electric powertrain components. It may incorporate advanced features such as heat pumps for cabin climate control and battery preconditioning.

Power connections 50 between HV components carry the main power flows within the system, such as from the battery 38 to the motor 44 during high load events, or from the charger 40 to the battery 38 during charging. These circuits are designed to handle voltages typically ranging from 400 to 800 volts in modern electric vehicles, with some systems pushing towards 1000 volts for improved efficiency.

The control and communication connections 52 allow the battery management system 46 to monitor and control various aspects of the powertrain's operation. For example, the control and communication connections 52 to the traction motor 44 carries speed and torque control signals, while the control and communication connections 52 to the traction battery 38 include data from the thermal management system 48, individual cell voltages, temperatures, and other battery monitoring sensors. These communication lines may utilize automotive-grade protocols such as controller area network or more other protocols like automotive ethernet.

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. An electrified vehicle system comprising:
a traction battery;
a plurality of electrically connected array modules within the traction battery, submerged in a cooling fluid; and
a sensing component, coupled with at least one of the electrically connected array modules and in contact with the cooling fluid, configured to detect a voltage drop across the sensing component when a contamination level in the cooling fluid reaches a threshold that increases electrical conductivity of the cooling fluid, and report a voltage drop across the sensing component to a traction battery monitoring system.

2. The electrified vehicle system of claim 1 wherein the sensing component is a high-precision resistive shunt.

3. The electrified vehicle system of claim 1 wherein the sensing component is a current sensor with low and high precision range capabilities.

4. The electrified vehicle system of claim 1, further comprising a plurality of sensing components, each coupled with a respective array module.

5. The electrified vehicle system of claim 1 wherein the traction battery monitoring system is configured to correlate the reported voltage drop with diagnostic data of a vehicle to determine a contamination level of the cooling fluid.

6. The electrified vehicle system of claim 5 wherein the traction battery monitoring system is further configured to classify the contamination level of the cooling fluid according to predetermined categories.

7. The electrified vehicle system of claim 6 wherein the traction battery monitoring system is further configured to disable one of the electrically connected array modules based on the contamination level.

8. The electrified vehicle system of claim 1 wherein the traction battery is coupled with a traction component.

9. An electrified vehicle system comprising:
a traction battery;
at least one array within the traction battery, immersed in a cooling fluid; and
a sensing component within the cooling fluid configured to detect a change in dielectric properties of the cooling fluid when a contamination level in the cooling fluid reaches a threshold that alters dielectric strength of the cooling fluid, measure the change in dielectric properties resulting from voltage flow of the at least one array through the cooling fluid, and communicate the measured change in dielectric properties to a traction battery monitoring system.

10. The electrified vehicle system of claim 9 wherein the dielectric strength of the cooling fluid is measured by the sensing component including at least one of electrical conductivity, dielectric constant, or impedance of the cooling fluid.

11. The electrified vehicle system of claim 9 wherein the sensing component comprises multiple electrodes positioned at different locations within the cooling fluid.

12. The electrified vehicle system of claim 9, further comprising a plurality of sensing components, each associated with a different array within the traction battery.

13. The electrified vehicle system of claim 9 wherein the traction battery monitoring system is configured to establish a baseline measurement of the dielectric properties and detect deviations from the baseline measurement.

14. The electrified vehicle system of claim 13 wherein the traction battery monitoring system is further configured to classify the deviations as indicating one of a plurality of predefined categories.

15. The electrified vehicle system of claim 9 wherein the traction battery monitoring system is configured to correlate the measured change in electrical properties with diagnostic data of a vehicle to determine a contamination level of the cooling fluid.

16. The electrified vehicle system of claim 15 wherein the diagnostic data includes temperature measurements of the cooling fluid.

17. The electrified vehicle system of claim 9 wherein the traction battery monitoring system is further configured to disable the at least one array based on the measured change in electrical properties.

18. The electrified vehicle system of claim 9 wherein the traction battery is connected to a traction component.

19. A battery module comprising:
a housing;
a plurality of arrays within the housing;
an immersion cooling fluid within the housing, in contact with a positive terminal and a negative terminal of the plurality of arrays;
a contamination detection circuit coupled with at least one of the plurality of arrays and in contact with the immersion cooling fluid, the contamination detection circuit configured to detect a current flow between the positive terminal and the negative terminal through the immersion cooling fluid when a contamination level in the immersion cooling fluid reaches a threshold that completes an electrical path; and
a battery module monitoring system configured to receive data indicative of the current flow from the contamination detection circuit due to a contamination level of the immersion cooling fluid, and to disable one of the plurality of arrays based on the contamination level having reached the threshold.

20. The battery module of claim 19 wherein the battery module monitoring system is further configured to adjust a charging rate of the plurality of arrays based on the contamination level.
